(19) United States
(12) Patent Application Publication
(10) Pub. No.: US 2024/0032092 A1
(43) Pub. Date: Jan. 25, 2024

(54) Uplink Enhancements For URLLC And IIoT In Unlicensed Band

(71) Applicant: MediaTek Singapore Pte. Ltd., Singapore (SG)

(72) Inventors: Abdellatif Salah, Cambridge (GB); Mohammed S Aleabe Al-Imari, Cambridge (GB); Chiou-Wei Tsai, Hsinchu City (TW)

(21) Appl. No.: 18/021,790

(22) PCT Filed: Aug. 17, 2021
(86) PCT No.: PCT/CN2021/112911

§ 371 Date: Feb. 16, 2023

Related U.S. Application Data
(60) Provisional application No. 63/066,880, filed on Aug. 18, 2020.

(51) Int. Cl. H04W 74/08

(52) U.S. Cl. CPC H04W 74/0808

(57) ABSTRACT

Various solutions for Ultra-Reliable Low-Latency Communication (URLLC) enhancement on unlicensed spectrum in mobile communications are described. An apparatus, implementable in a UE, obtains a UE-initiated channel occupancy time (COT). The apparatus then performs an uplink (UL) transmission to a network during the UE-initiated COT.

### CROSS REFERENCE TO RELATED APPLICATION(S)

The present disclosure is part of U.S. National Stage filing of International Patent Application No. PCT/CN2021/112911, filed 17 Aug. 2021, which is part of a non-provisional application claiming the priority benefit of U.S. Patent Application No. 63/066,880, filed 18 Aug. 2020, the content of which being incorporated by reference in its entirety.

### TECHNICAL FIELD

The present disclosure is generally related to mobile communications and, more particularly, to techniques for uplink enhancements for Ultra-Reliable Low-Latency Communication (URLLC) and Industrial Internet of Things (IIoT) in unlicensed band in mobile communications.

### BACKGROUND

Unless otherwise indicated herein, approaches described in this section are not prior art to the claims listed below and are not admitted as prior art by inclusion in this section.

In wireless communications, such as mobile communications under the 3rd Generation Partnership Project (3GPP) specification(s) for 5th Generation (5G) New Radio (NR), two types of listen-before-talk (LBT) channel access are employed, namely Load Based Equipment (LBE) and Frame Based Equipment (FBE). In FBE-based LBT, a user equipment (UE) is allowed to perform clean channel assessment (CCA) to sense if a channel is idle, and this is done for every fixed frame period (FFP). If and when the UE accesses the channel, the UE would occupy the channel for a fixed period of time known as a channel occupancy time (COT), and then the UE would wait for a period equal to 5% of the COT for a next transmission. This period is referred to as an idle period herein.

In Release 16 (Rel-16) of the 3GPP specification, regarding FBE, only a base station (e.g., gNB) initiated COT is supported. This, however, may impose scheduling and configuration restrictions on uplink (UL) transmissions, thereby impacting latency of UL traffic. To transmit in the UL direction, a UE would need to determine whether the gNB has initiated a COT in the FFP. If the gNB did not initiate a COT, then the UE would need to wait for a gNB COT and this would cause extra latency. For uplink configured grant (UL-CG), the UE needs to check always whether a COT in the FFP is initiated by the gNB by monitoring downlink (DL) transmissions at the beginning of the FFP. Undesirably, this would result in excessive power consumption at the UE and costly operation at the UE side. Therefore, there is a need for a solution to achieve uplink enhancements for low-latency applications and low-power applications, such as URLLC and IIoT, in unlicensed band in mobile communications.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for uplink enhancements for URLLC and IIoT in unlicensed band in mobile communications. For instance, under various schemes proposed herein, a UE-initiated COT may be enabled for the purpose of supporting URLLC in controlled unlicensed-band environments operating based on FBE structure. It is believed that the latency budget and power consumption may be considerably improved by allowing UE-initiated COT in a semi-static channel access mode.

In one aspect, a method may involve a UE obtaining a UE-initiated COT in a FBE mode. The method may also involve the UE performing an UL transmission to a network in the UE-initiated COT.

In another aspect, an apparatus implementable in a UE may include a transceiver and a processor coupled to the transceiver. The transceiver may be configured to wirelessly communicate with a network. The processor may obtain, via the transceiver, a UE-initiated COT in a FBE mode. The processor may also perform, via the transceiver, an UL transmission to the network in the UE-initiated COT.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under various proposed schemes in accordance with the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to uplink enhancements for URLLC and IIoT in unlicensed band in mobile communications. According to the present disclosure, a number of possible solutions may be implemented separately or jointly. That is, although these possible solutions may be described below separately, two or more of these possible solutions may be implemented in one combination or another.

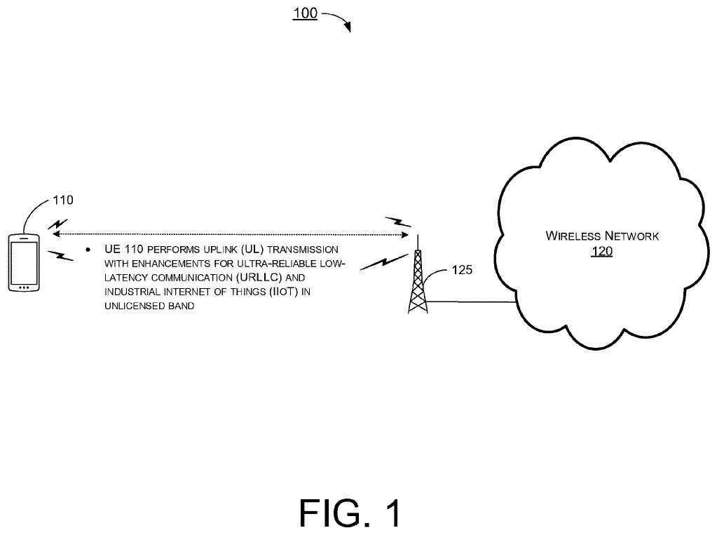

FIG. 1 illustrates an example network environment 100 in which various solutions and schemes in accordance with the present disclosure may be implemented. Referring to FIG. 1, network environment 100 may involve a user equipment (UE) 110 in wireless communication with a wireless network 120 (e.g., a 5G NR mobile network or another type of network such as an NTN). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to uplink enhancements for URLLC and IIoT in unlicensed band in mobile communications, as described below.

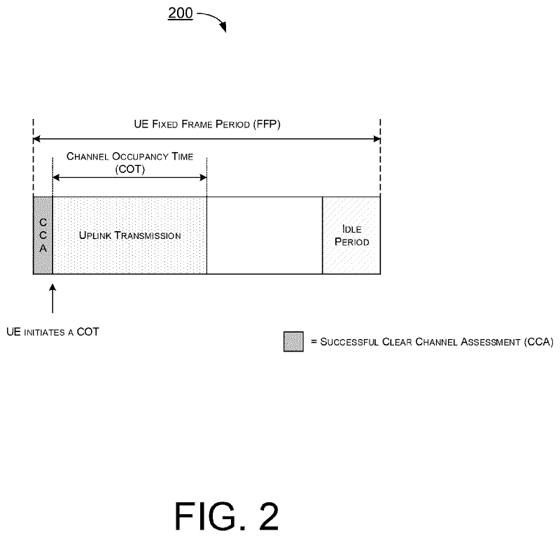

FIG. 2 illustrates an example scenario 200 under various proposed schemes in accordance with the present disclosure. Referring to FIG. 2, under the various proposed schemes in accordance with the present disclosure, a UE (e.g., UE 110) may initiate a COT in an FFP associated with the UE, in case the UE performs an UL transmission burst under the following conditions: (1) starting at the beginning of the FFP, (2) ending at any symbol before the FFP's idle period, and (3) after a successful CCA of 9 microseconds (μs) immediately before the UL transmission burst.

It is noteworthy that a UE-initiated COT in FBE operations is relevant for URLLC mainly for UL-CG with periodic or semi-persistent traffic to improve the latency in unlicensed band. As not all UEs are required to implement this functionality, the ability to perform UE-initiated COT in FBE may be defined as a UE capability. Under a first proposed scheme in accordance with the present disclosure, in FBE operations, a UE-initiated COT may be defined as a UE capability. Additionally, under the proposed scheme, UE 110 may report to network 120 its support of UE-initiated COTs in FBE. UE 110 may also report its supported and/or preferred FBE frame periods and its supported and/or preferred offsets. Alternatively, or additionally, UE 110 may report its supported FBE frame periods and its preferred offsets per numerology and/or per UE processing capability, in addition to reporting FFP parameters such as periodicity and offset. Moreover, network node 125 may configure or not configure UE 110 with the UE-initiated COT. Under the proposed scheme, the UE-initiated COT operation in FBE may be configured or triggered dynamically. For instance, UE 110 may be allowed to initiate a COT based on a scheduling request (SR) priority or per SR configuration. The UE-initiated COT may be triggered dynamically with an explicitly new dedicated downlink control information (DCI) field, with an existing DCI field (e.g., the priority field), implicitly based on a DCI format, a specific radio network temporary identifier (e.g., MCS-C-RNTI), a specific search space or a control resource set (CORESET), or with a group common DCI (GC-DCI).

It is noteworthy that a UE initiates a COT for UL transmission; however, receiving of DL data is still open particularly with respect to physical downlink control channel (PDCCH) monitoring. Under a second proposed scheme in accordance with the present disclosure, in FBE operations, UE 110 may monitor PDCCH or may skip PDCCH monitoring during a UE-initiated COT. Alternatively, in FBE operations, PDCCH monitoring during a UE-initiated COT may be defined as a UE capability. Accordingly, UE 110 may report to network 120 its capability of monitoring PDCCH during a UE-initiated COT. Moreover, in FBE operations, network node 125 may configure UE 110 with PDCCH monitoring during a UE-initiated COT. Alternatively, PDCCH monitoring may be allowed only within a network-initiated COT. Alternatively, in case a UE-initiated COT is shared with network node 125, UE 110 may monitor PDCCH or otherwise UE 110 would not monitor it. Under the proposed scheme, network node 125 may, during a network-initiated COT, dynamically signal to UE 110 to monitor PDCCH in the next UE-initiated COT. Under the proposed scheme, a specific PDCCH configuration (e.g., monitoring periodicity, search space set, CORESETs, and so on) may be configured for a given UE (e.g., UE 110) for its UE-initiated COTs and UE 110 may automatically switch to the new configuration during its initiated COTs.

It is noteworthy that in case a UE-initiated COT is enabled for all UEs, URLLC UL transmission and UEs may be given priority to access a channel especially in case the collision probability is higher than a block error ratio (BLER) target (e.g., 10-6) or in case the average extra latency is above a packet delay budget. That is, a transmission of an enhanced mobile broadband (eMBB) UE may not block the transmission of a URLLC UE. It is also noteworthy that UL preemption is one way to give priority to URLLC UL transmission, but it requires the gNB to initiate a COT and transmit a group common PDCCH (GC-PDCCH) for this purpose. Under a third proposed scheme in accordance with the present disclosure, a high-priority LBT class may be allocated for URLLC transmissions and URLLC UEs or a specific mechanism may be defined for FBE UE-initiated COTs. Alternatively, under the proposed scheme, network node 125 may cancel a COT for a low-priority traffic of a particular UE and use it for high-priority DL traffic and/or to allow another UE to use it instead for a high-priority UL traffic.

It is noteworthy that FFP of 1 or 2 milliseconds (ms) would be ideal for URLLC services from latency perspective. However, FBE operations tend to have a minimum idle period of 100 μs which would impact the spectral efficiency in case FFP is smaller than 2 ms (<95% of the FFP), e.g., 10% of time not being used for transmission when FFP=1 ms. On the other hand, URLLC operations tend to be very resource-demanding and thus spectral efficiency is crucial. Also, gNB sharing of COTs tends to consume resources. Under a fourth proposed scheme in accordance with the present disclosure, network node 125 may be restricted from sharing the UE-initiated COT in case UE 110 is transmitting high-priority traffic. For instance, network node 125 may be allowed to share a COT for transmission or scheduling of high-priority traffic for a same UE or different UEs. Moreover, network node 125 may be allowed to share a COT for UL preemption. Alternatively, network node 125 may share the UE-initiated COT only in case UE 110 initiated the COT to send an SR or a configured grant physical uplink shared channel (CG-PUSCH).

It is also noteworthy that a UE-initiated COT is proposed mainly for UL transmission and particularly for CG transmissions where the UE could initiate the transmission without prior scheduling. Under the fourth proposed scheme, a UE-initiated COT may be restricted to a CG-PUSCH transmission and/or to an SR transmission. Alternatively, scheduled UL transmissions may be restricted to gNB-initiated COTs. Alternatively, a UE-initiated COT may be restricted to a specific part of a gNB FFP. Currently, in Rel-16 NR-U, UEs need to wait to decode DL signals before using a gNB-initiated COT, which means UL transmissions are more difficult to accommodate in the beginning of the gNB-initiated COT but easier to accommodate towards the end of the gNB-initiated COT. Thus, UE 110 may be configured to use only a specific part of the gNB FFP to initiate a COT (e.g., the second half of the gNB FFP). Alternatively, UE offsets may be defined to verify a specific condition. For instance, UE_offset≥gNB_offset+X, where Xϵ[0, FFP_duration], e.g., X=ceiling {FFP_duration/2}. The same condition may apply to the gNB sharing a UE-initiated COT. Alternatively, UE 110 may not be allowed to initiate a COT during a gNB-initiated COT.

It is noteworthy that aligning all FFPs with a frame boundary tends to increase the probability of collision, which is not ideal for URLLC traffic. Under a fifth proposed scheme in accordance with the present disclosure, more granularities of a FFP start may be defined for UE-initiated COTs may be useful to reduce probability of collision between transmissions by multiple UEs. For instance, a FFP start offset may be defined with one slot granularity. Alternatively, a FFP start offset may be defined with a sub-slot granularity. Moreover, a FFP period may be defined in sub-slots. Furthermore, some offsets may be restricted or otherwise specified for UEs with high-priority traffic. Under the proposed scheme, UL data crossing a slot boundary may be allowed for a UE-initiated COT at least for an FFP starting during a slot. Moreover, configurable offset(s) may be defined so that an FFP initiated by a UE (e.g., UE 110) for an UL transmission would not collide with a gNB-initiated COT for a DL transmission.

It is noteworthy that a UE having a high-priority UL traffic needs to wait to initiate a COT or for a gNB to initiate another COT to be able to transmit, and this is not ideal from latency perspective. Under a sixth proposed scheme in accordance with the present disclosure, a UE (e.g., UE 110) may share a COT initiated by another UE for a high-priority transmission. Under the proposed scheme, this behavior may be allowed by a gNB (e.g., network node 125). For instance, when UE 110 has finished its UL transmission during a COT initiated by UE 110, network node 125 may exploit the same COT by scheduling another UE and receive an UL transmission from that other UE. Moreover, a flag in the scheduling DCI may be included to allow a UE to use a COT that is being shared or, alternatively, this may be determined implicitly by the resource(s) scheduled for the UL transmission. Furthermore, a UE-initiated COT shared with the gNB may be shared with other UE(s) (by the gNB) using the same mechanism as for a gNB-initiated COT.

It is noteworthy that different UEs may have COTs initiated and collision may happen between hidden nodes even under the same gNB. This may cause an issue for URLLC UEs and may impact reliability. Under a seventh proposed scheme in accordance with the present disclosure, multiple options may be utilized to address this issue. For instance, in a first option, a gNB (e.g., network node 125) may broadcast a signal subsequent to a UE (e.g., UE 110) initiating a COT (and hence the signal is broadcast within the UE-initiated COT) to inform other UEs that the medium is occupied. In a second option, CCA threshold may be increased for some UEs, such as those UEs with low-priority traffic. The threshold may be adjusted dynamically or semi-statically. In a third option, a CCA sensing duration may be increased for some UEs, such as those UEs with low-priority traffic. The CCA sensing duration may be adjusted dynamically or semi-statically.

It is noteworthy that, due to different offsets and FFP periodicities, there is higher likelihood for a gNB and some UEs to have difficulty in accessing a channel at the beginning of their FFP. Thus, the gNB and UEs with high-priority traffic should be given a higher priority to access the channel. Under an eighth proposed scheme in accordance with the present disclosure, some extra idle periods may be defined in addition to the existing FFP idle period. Such newly defined idle periods may be signaled or otherwise configured to some UEs and, during the signaled/configured idle periods, those specific UEs may not be allowed to transmit and/or attempt to access the channel. The idle periods may have a specific pattern or may be contiguous, and they may be enabled or disabled. Under the proposed scheme, an UL transmission by a UE (e.g., UE 110) during its UE-initiated COT may overlap with an idle period of a gNB-initiated COT. This may be allowed for some UEs, such as those UEs configurable to use or not use gNB idle periods during their own COTs, or for UEs with high-priority traffic only.

It is noteworthy that, to reduce the risk of collisions between UEs and also give some opportunities for UEs with more frequent high-priority traffic, some FFP patterns may be introduced. Under a ninth proposed scheme in accordance with the present disclosure, as with time-division duplexing (TDD) UL/DL patterns, UE-initiated COTs may have a specific pattern in order to reduce the risk of collisions between UEs and to give some opportunities for UEs with more frequent high-priority UL traffic. For instance, the pattern may involve 2 FFPs+1 skipped FFP, and a UE may initiate a COT during two successive FFPs but need to skip the third FFP. The patterns may be configured for UEs and/or modified dynamically through DCI.

It is noteworthy that a UE may initiate a COT or transmit within a gNB-initiated COT some high-priority traffic, and the COT may expire before the transmission of UL data is completed. In such cases, the UE may send a buffer status report (BSR) to the gNB. The gNB may initiate a new COT but latency may be an issue since the UE needs first to detect some DL signals. The UE may also initiate a new COT but the risk of not obtaining the new COT is high especially if many other UEs are sharing the medium. Under a tenth proposed scheme in accordance with the present disclosure, a gNB (e.g., network node 125) may broadcast a signal asking some or most UEs to refrain from using the next FFP to allow a given UE with a particular high-priority traffic to continue sending its traffic. For instance, network node 125 may use GC-DCI to inform one or more UEs to skip initiating their COTs in some specific FFP(s). Moreover, UE 110 may support this feature as a UE capability.

### Illustrative Implementations

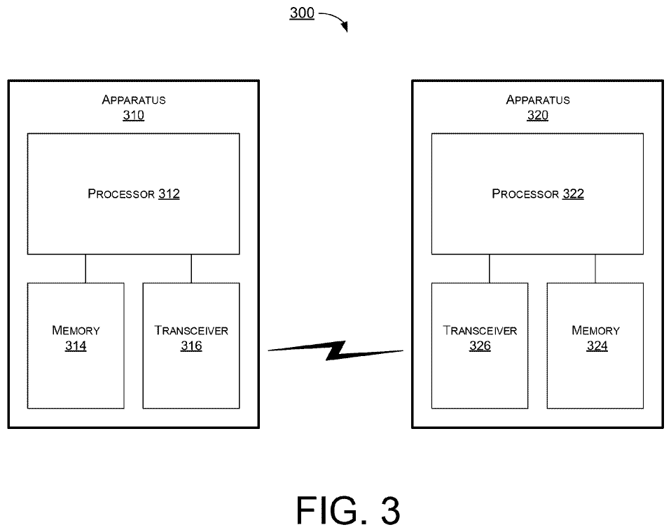

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to uplink enhancements for URLLC and IIoT in unlicensed band in mobile communications, including scenarios/schemes described above as well as processes described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus/station, which may be a network node such as a base station, a small cell, a router, a gateway or a satellite. For instance, network apparatus 320 may be implemented in an eNodeB in an LTE, in a gNB in a 5G, NR, IoT, NB-IoT, IIoT, or in a satellite in an NTN network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, one or more RISC processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

Each of communication apparatus 310 and network apparatus 320 may be a communication entity capable of communicating with each other using various proposed schemes in accordance with the present disclosure. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE (e.g., UE 110) and network apparatus 320 is implemented in or as a network node or base station (e.g., network node 125) of a communication network (e.g., wireless network 120). It is also noteworthy that, although the example implementations described below are provided in the context of mobile communications, the same may be implemented in other types of networks.

Under a proposed scheme pertaining to uplink enhancements for URLLC and IIoT in unlicensed band in mobile communications in accordance with the present disclosure, with communication apparatus 310 implemented in or as UE 110 and network apparatus 320 implemented in or as network node 125 in network environment 100, processor 312 of communication apparatus 310 may obtain, via transceiver 316, a UE-initiated COT in a FBE mode. Furthermore, processor 312 may perform, via transceiver 316, an UL transmission to a network (e.g., network 120 via apparatus 320 as network node 125) in the UE-initiated COT.

In some implementations, in performing the UL transmission, processor 312 may transmit UL data which crosses a slot boundary.

In some implementations, the UL data may cross the slot boundary for an FFP starting during a slot.

In some implementations, the UE-initiated COT may be defined as a UE capability in the FBE mode.

In some implementations, in performing the UL transmission, processor 312 may perform the UL transmission with an offset configurable to apparatus 310 such that an FFP initiated by apparatus 310 for the UL transmission does not collide with a network-initiated COT.

In some implementations, in performing the UL transmission in the UE-initiated COT, processor 312 may share the UE-initiated COT which is initiated by another UE.

In some implementations, in performing the UL transmission, processor 312 may further transmit an URLLC traffic.

In some implementations, the UE-initiated COT may also be shared with a base station (e.g., apparatus 320 as network node 125) of the network.

In some implementations, in sharing the UE-initiated COT, processor 312 may perform certain operations. For instance, processor 312 may receive, via transceiver 316, from the network a scheduling DCI the content of which indicating (e.g., with a flag in the DCI) whether the UE is allowed to share the UE-initiated COT. Additionally, processor 312 may utilize, via transceiver 316, the UE-initiated COT responsive to receiving the scheduling DCI.

In some implementations, in sharing the UE-initiated COT, processor 312 may perform other operations. For instance, processor 312 may determine that the UE is allowed to share the UE-initiated COT based on one or more resources scheduled for the UL transmission. Moreover, processor 312 may utilize, via transceiver 316, the UE-initiated COT responsive to the determining.

In some implementations, the UL transmission in the UE-initiated COT may overlap with an idle period of a base station-initiated COT (e.g., initiated by apparatus 320).

In some implementations, processor 312 may either perform PDCCH monitoring or skip the PDCCH monitoring during the UE-initiated COT. Apparatus 310 may be configured by the network (e.g., via apparatus 320) to perform the PDCCH monitoring during the UE-initiated COT or within a base station-initiated COT.

### Illustrative Processes

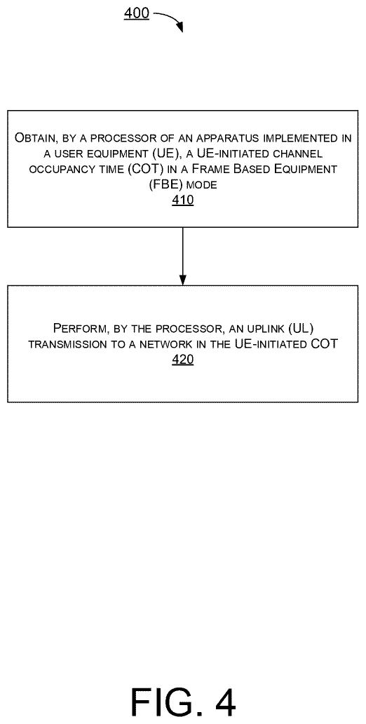

FIG. 4 illustrates an example process 400 in accordance with an implementation of the present disclosure. Process 400 may be an example implementation of schemes described above, whether partially or completely, with respect to uplink enhancements for URLLC and IIoT in unlicensed band in mobile communications in accordance with the present disclosure. Process 400 may represent an aspect of implementation of features of communication apparatus 310 and network apparatus 320. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices as well as by and network apparatus 320 or any suitable network node or base station. Solely for illustrative purposes and without limitation, process 400 is described below in the context of communication apparatus 310 and network apparatus 320. Process 400 may begin at block 410.

At 410, process 400 may involve processor 312 of communication apparatus 310, implemented in or as UE 110, obtaining, via transceiver 316, a UE-initiated COT in a FBE mode. Process 400 may proceed from 410 to 420.

At 420, process 400 may involve processor 312 performing, via transceiver 316, an UL transmission to a network (e.g., network 120 via apparatus 320 as network node 125) in the UE-initiated COT.

In some implementations, in performing the UL transmission, process 400 may involve processor 312 transmitting UL data which crosses a slot boundary.

In some implementations, the UL data may cross the slot boundary for an FFP starting during a slot.

In some implementations, the UE-initiated COT may be defined as a UE capability in the FBE mode.

In some implementations, in performing the UL transmission, process 400 may involve processor 312 performing the UL transmission with an offset configurable to apparatus 310 such that an FFP initiated by apparatus 310 for the UL transmission does not collide with a network-initiated COT.

In some implementations, in performing the UL transmission in the UE-initiated COT, process 400 may involve processor 312 sharing the UE-initiated COT which is initiated by another UE.

In some implementations, in performing the UL transmission, process 400 may further involve processor 312 transmitting an URLLC traffic.

In some implementations, the UE-initiated COT may also be shared with a base station (e.g., apparatus 320 as network node 125) of the network.

In some implementations, in sharing the UE-initiated COT, process 400 may involve processor 312 performing certain operations. For instance, process 400 may involve processor 312 receiving, via transceiver 316, from the network a scheduling DCI the content of which indicating (e.g., with a flag in the DCI) whether the UE is allowed to share the UE-initiated COT. Additionally, process 400 may involve processor 312 utilizing, via transceiver 316, the UE-initiated COT responsive to receiving the scheduling DCI.

In some implementations, in sharing the UE-initiated COT, process 400 may involve processor 312 performing other operations. For instance, process 400 may involve processor 312 determining that the UE is allowed to share the UE-initiated COT based on one or more resources scheduled for the UL transmission. Moreover, process 400 may involve processor 312 utilizing, via transceiver 316, the UE-initiated COT responsive to the determining.

In some implementations, the UL transmission in the UE-initiated COT may overlap with an idle period of a base station-initiated COT (e.g., initiated by apparatus 320).

In some implementations, process 400 may further involve processor 312 either performing PDCCH monitoring or skipping the PDCCH monitoring during the UE-initiated COT. Apparatus 310 may be configured by the network (e.g., via apparatus 320) to perform the PDCCH monitoring during the UE-initiated COT or within a base station-initiated COT.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
obtaining, by a processor of an apparatus implemented in a user equipment (UE), a UE-initiated channel occupancy time (COT) in a Frame Based Equipment (FEE) mode; and
performing, by the processor, an uplink (UL) transmission to a network in the UE-initiated COT.

2. The method of claim 1, wherein the performing of the UL transmission comprises transmitting UL data which crosses a slot boundary, and wherein the UL data crosses the slot boundary for a fixed frame period (FFP) starting during a slot.

3. The method of claim 1, wherein the UE-initiated COT is defined as a UE capability in the FBE mode.

4. The method of claim 1, wherein the performing of the UL transmission comprises performing the UL transmission with an offset configurable to the UE such that a fixed frame period (FFP) initiated by the UE for the UL transmission does not collide with a network-initiated COT.

5. The method of claim 1, wherein the performing of the UL transmission in the UE-initiated COT comprises sharing the UE-initiated COT which is initiated by another UE.

6. The method of claim 5, wherein the performing of the UL transmission further comprises transmitting an ultra-reliable low-latency communication (URLLC) traffic.

7. The method of claim 5, wherein the UE-initiated COT is also shared with a base station of the network.

8. The method of claim 5, wherein the sharing of the UE-initiated COT comprises:
receiving from the network a scheduling downlink control information (DCI), wherein a content in the scheduling DCI indicates whether the UE is allowed to share the UE-initiated COT; and
utilizing the UE-initiated COT responsive to receiving the scheduling DCI.

9. The method of claim 5, wherein the sharing of the UE-initiated COT comprises:
determining that the UE is allowed to share the UE-initiated COT based on one or more resources scheduled for the UL transmission; and
utilizing the UE-initiated COT responsive to the determining.

10. The method of claim 1, wherein the UL transmission in the UE-initiated COT overlaps with an idle period of a base station-initiated COT.

11. The method of claim 1, further comprising:
performing physical downlink control channel (PDCCH) monitoring; or
skipping the PDCCH monitoring during the UE-initiated COT,
wherein the UE is configured by the network to performing the PDCCH monitoring during the UE-initiated COT or within a base station-initiated COT.

12. An apparatus implementable in a user equipment (UE), comprising:
a transceiver configured to wirelessly communicate with a network; and
a processor coupled to the transceiver and configured to perform operations comprising:
obtaining, via the transceiver, a UE-initiated channel occupancy time (COT) in a Frame Based Equipment (FBE) mode; and
performing, via the transceiver, an uplink (UL) transmission to the network in the UE-initiated COT.

13. The apparatus of claim 12, wherein, in performing the UL transmission, the processor transmits UL data which crosses a slot boundary, and wherein the UL data crosses the slot boundary for a fixed frame period (FNP) starting during a slot.

14. The apparatus of claim 12, wherein, in performing the UL transmission, the processor performs the UL transmission with an offset configurable to the UE such that a fixed frame period (FFP) initiated by the UE for the UL transmission does not collide with a network-initiated COT.

15. The apparatus of claim 12, wherein, in performing the UL transmission in the UE-initiated COT, the processor shares the UE-initiated COT which is initiated by another UE.

16. The apparatus of claim 15, wherein, in performing the UL transmission, the processor further transmits an ultra-reliable low-latency communication (URLLC) traffic.

17. The apparatus of claim 15, wherein the UE-initiated COT is also shared with a base station of the network.

18. The apparatus of claim 15, wherein, in sharing the UE-initiated COT, the processor performs operations comprising:
receiving from the network a scheduling downlink control information (DCI), wherein a content in the scheduling DCI indicates whether the UE is allowed to share the UE-initiated COT; and
utilizing the UE-initiated COT responsive to receiving the scheduling DCI.

19. The apparatus of claim 15, wherein, in sharing the UE-initiated COT, the processor performs operations comprising:
determining that the UE is allowed to share the UE-initiated COT based on one or more resources scheduled for the UL transmission; and
utilizing the UE-initiated COT responsive to the determining.

20. The apparatus of claim 12, wherein the UL transmission in the UE-initiated COT overlaps with an idle period of a base station-initiated COT.
